(19) United States
(12) Patent Application Publication
(10) Pub. No.: US 2010/0035125 A1
(43) Pub. Date: Feb. 11, 2010

(54) LAYERED ELECTRODE FOR ELECTROCHEMICAL CELLS

(75) Inventors: THOMAS A. GRESZLER, Rochester, NY (US); MATTHEW M. FAY, Fairport, NY (US); SCOTT L. PETERS, Rochester, NY (US); JOHN C. DOYLE, Bergen, NY (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/186,795

(22) Filed: Aug. 6, 2008

(51) Int. Cl. H01M 4/86; B32B 38/10

(52) U.S. Cl. 429/42; 429/40; 156/247; 156/60

(57) ABSTRACT

One exemplary embodiment may include an electrode including a hydrophobic material.

### TECHNICAL FIELD

The technical field relates to electrodes for use in electrochemical cells. In particular, the field relates to electrodes and membrane electrode assemblies for use in fuel cells.

### BACKGROUND

Electrochemical cells are desirable for various applications, particularly when operated as fuel cells. Fuel cells have been proposed for many applications including electrical vehicular power plants to replace internal combustion engines. One fuel cell design uses a solid polymer electrolyte (SPE) membrane or proton exchange membrane (PEM), to provide proton exchange between the cathode and anode. Gaseous and liquid fuels are useable within fuel cells. Examples include hydrogen and methanol, and hydrogen is favored. Hydrogen is supplied to the fuel cell's anode. Oxygen (as air) is the fuel cell oxidant and is supplied to the fuel cell's cathode. The electrodes have been formed on gas diffusion media layers which may be made from porous conductive materials that, such as woven graphite, graphitized sheets, or carbon paper to enable the fuel to disperse over the surface of the membrane facing the fuel supply electrode. Fuel cell electrodes have typically included a catalyst supported on carbon particles with an ionomer binder. Examples of fuel cells are described in U.S. Pat. Nos. 5,272,017 and 5,316,871 to Swathirajan et al.

### SUMMARY OF EXEMPLARY EMBODIMENTS OF THE INVENTION

One exemplary embodiment may include an electrode for use in a fuel cell including a hydrophobic material.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the invention will become more fully understood from the detailed description and the accompanying drawings; wherein:

FIG. 1 illustrates a portion of a fuel cell stack including an electrode coated with a hydrophobic layer according to one exemplary embodiment;

FIG. 2 is a close-up view of a portion of the fuel cell stack of FIG. 1;

FIG. 3 is a graphical illustration that compares the voltage at 1.2 amps per squared centimeter of an electrode under wet conditions with and without a hydrophobic layer in accordance with one exemplary embodiment; and

FIG. 4 is a graphical illustration that compares the voltage at 1.2 amps per squared centimeter of an electrode under dry conditions with and without a hydrophobic layer in accordance with one exemplary embodiment.

### DETAILED DESCRIPTION OF THE EXEMPLARY EMBODIMENTS

The following description of the embodiment(s) is merely exemplary (illustrative) in nature and is in no way intended to limit the invention, its application, or uses.

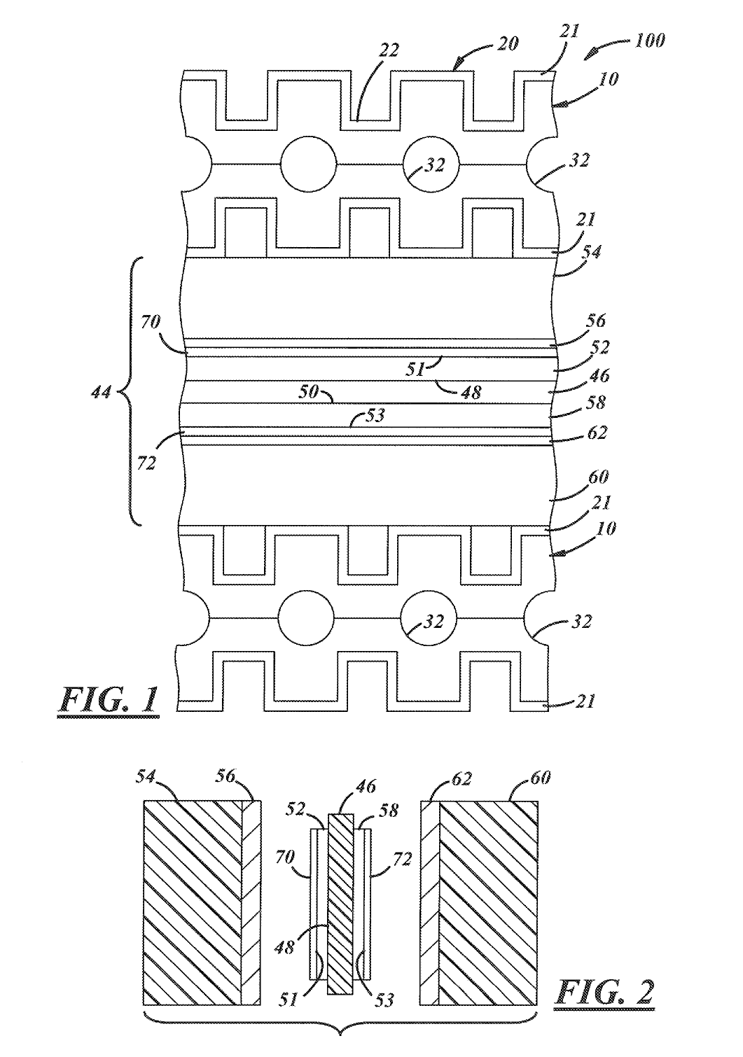

Referring now to FIG. 1, one exemplary embodiment includes a product 100 such as a fuel cell stack, here being a PEM (proton exchange membrane) fuel cell stack, including a soft goods portion 44 which may include a membrane 46 having a first face 48 and a second face 50, a cathode electrode 52 may be provided over the first face 48 of the membrane 46 and an anode electrode 58 may be provided over the second face 50 of the membrane 46. The fuel cell stack 100 includes a bipolar plate 10 that may include one or more lands 20 and channels 22. The bipolar plate 10 may be configured to define one or more coolant flow channels 32 for flowing cooling fluid through the center of the bipolar plate 10 to cool same. Hydrophilic, hydrophobic and/or low contact resistance coatings 21 may be provided over faces of the bipolar plate 10.

The fuel cell stack 100 may also include a cathode side gas diffusion media layer 54 which may have a microporous layer 56 thereon may be interposed between the cathode electrode 52 and the bipolar plate 10. Similarly, an anode side gas diffusion media layer 60 having a microporous layer 62 thereon may be interposed between the anode catalyst layer 58 and a second bipolar plate 10.

As shown best in FIG. 2, an electrically conductive hydrophobic layer 70 may be provided over a first surface 51 of the cathode electrode 52 and a second electrically conductive hydrophobic layer 72 may be provided over a first surface 53 of the anode electrode 58. The hydrophobic layer 70, 72 may be provided in an overlying position with the cathode or anode electrodes 52, 58 respectively, and applied by any of a number of processes or application methods.

The electrodes (the cathode electrode 52 and the anode electrode 58) may be catalyst layers which may include catalyst particles and an ion conductive material such as a proton conducting ionomer, intermingled with the particles. The proton conductive material may be an ionomer such as a perfluorinated sulfonic acid polymer. The catalyst materials may include, but not limited to, metals such as platinum, palladium, and mixtures of metals such as platinum and molybdenum, platinum and cobalt, platinum and ruthenium, platinum and nickel, platinum and tin, other platinum transition-metal alloys, and other fuel cell electrocatalysts known in the art. The catalyst materials may be finely divided if desired. The catalyst materials may be unsupported or supported on a variety of materials such as but not limited to finely divided carbon particles. As such, the catalyst layers of the electrode may be formulated at an ionomer to carbon (I/C) mass ratio.

The electrode (the cathode electrode 52 or the anode electrode 58) may be formed, according to one embodiment, by first mixing the catalyst particles, typically platinum dispersed on carbon, with an ionomer and a solvent.

Depending upon the application, the mixture may be formulated at a particularly desired I/C ratio. Next, the mixture may be milled or blended until the catalyst particles are well dispersed. The mixture may then be applied directly to the surface of the electrode and dried to remove the solvent.

Alternatively, the mixture may be coated onto a decal to form an electrode coated decal and then dried to remove the solvent. A decal as described herein may be a thin polymer film such as ethylene tetrafluoroethylene (ETFE), polytetrafluoroethylene (PTFE), or polyethylene (PE). Finally, the anode electrode coated decal and the cathode electrode coated decal may be transferred onto opposite respective sides 48, 50 of the membrane 46 via a lamination or other application process. Alternatively, the mixture may be applied to an ion conductive membrane that may or may not be supported by a substrate, decal or catalyst coated diffusion media.

The electrically conductive hydrophobic layer 70, 72 may be formed by blending electrically conductive particles, such as but not limited to carbon, with a hydrophobic material to form a mixture. The mixture may also include solvents and surfactants. Preferably, the mixture may be milled or blended to ensure that the carbon particles and hydrophobic material is well dispersed. This mixture may be then applied directly to the exterior surface of the electrode or alternatively to a substrate material using any number of application methods. Some non-limiting examples of application methods for applying the mixture include but are not limited to slot-die coating, doctor blade coating, spraying, and rod coating. In one exemplary embodiment the substrate may be ethylene tetrafluoroethylene (ETFE), Kapton® polyimide film (available from E.I. du Pont de Nemours), or polytetrafluoroethylene (PTFE) films.

The mixture may be then dried on the substrate to remove solvent. Finally, the mixture may be treated at an elevated temperature, preferably between about 200 and 600 degrees Celsius, to remove the surfactant and sinter the hydrophobic material to form an electrically conductive hydrophobic layer 70, 72. The electrically conductive hydrophobic layer 70, 72 may, in one exemplary embodiment, may then be applied over the first surface 51 of the cathode electrode 52, or over the first surface 53 of the anode electrode 58, or both, via a lamination, hot pressing or similar application method to bond or otherwise adhere the hydrophobic layer 70, 72 to the first surface 51, 53 wherein the substrate is removed. In various embodiments the resultant layer 70, 72 may have a thickness of about 0.5-50 micrometers, 1.0-30 micrometers, 2-15 micrometers, 8-12 micrometer or about 10 micrometers.

The hydrophobic material within the electrically conductive hydrophobic layer 70, 72 is not an ion exchange material; that is, the hydrophobic material is not selected from materials used to make polymer electrolytes. In one exemplary embodiment, the hydrophobic material may be selected from fluorinated polymers (i.e. a polymeric material including at least one fluorine atom). Non-limiting examples of the fluorinated polymers that may be utilized include at least one of polytetrafluoroethylene (PTFE), fluorinated ethylene-propylene (FEP), perfluoroalkoxy polymer resin (PFA), methylfluoroalkoxy polymer resin (MFA), polychlorotrifluroethylene (PCTFE), polyvinylidene fluoride (PVDF), polyvinyl fluoride (PVF), or ethylene chlorotrifluroethylene (ETFE); copolymers of fluorinated polymers may also be included, such as a copolymer of tetrafluoroethylene, hexafluoropropylene and vinylidene fluoride (THV). The relative amount of hydrophobic material to electrically conductive particles in the electrically conductive hydrophobic layer 70, 72 may vary, depending upon numerous factors, including the thickness of the coated layer and the I/C ratio of the underlying electrode. In general, however, the amount of hydrophobic particles should be sufficient to provide the surface with sufficient hydrophobicity, while operating under wet conditions, to maintain a substantially constant and high voltage at a given current density as compared with electrodes not including the hydrophobic layer 70, 72. In one exemplary embodiment the weight ratio of electrically conductive particles to hydrophobic particles in the dried electrically conductive hydrophobic layer 70, 72 may range from about 2 to 9.

Again, the electrically conductive hydrophobic layer 70, 72 may be provided overlying the electrodes 52, 58 respectively by a number of application methods. In one embodiment the electrically conductive hydrophobic layer 70, 72 may be deposited over a decal or over a gas diffusion media layer or over a microporous layer on a gas diffusion media layer. The electrode 52, 58 may be deposited over the electrically conductive hydrophobic layer 70, 72 after the electrically conductive hydrophobic layer 70, 72 has dried or while the layer 70, 72 is still wet or tacky. If a decal is used, the electrode 52, 58 and overlying hydrophobic layer 70, 72 may be hot pressed to a membrane.

In another embodiment, the electrode 52, 58 may be deposited on a decal to form an electrode coated decal and the electrically conductive hydrophobic layer 70, 72 may be subsequently deposited on the electrode coated decal. The resultant assembly may be hot pressed to a gas diffusion media layer or a microporous layer thereon so that the electrically conductive hydrophobic layer 70, 72 is interposed between the gas diffusion media layer and the electrode coated decal.

In yet another embodiment, the electrically conductive hydrophobic layer 70, 72 may be deposited or applied over each electrode of a membrane electrode assembly (MEA). In one embodiment, the electrically conductive hydrophobic layer 70, 72 is bonded to one of the electrodes 52, 58.

The gas diffusion media layers 54, 60 may include any electrically conductive porous material. In various embodiments, the gas diffusion media layer 54, 60 may include non-woven carbon fiber paper or woven carbon cloth which may be treated with a hydrophobic material, such as, but not limited to, polymers of polyvinylidene fluoride (PVDF), fluoroethylene propylene, or polytetrafluoroethylene (PTFE). The gas diffusion media layer may have an average pore size ranging from 5-40 micrometers. The gas diffusion media layer 54, 60 may have a thickness ranging from about 100 to about 500 micrometers.

The microporous layer 56, 62 may be made from materials such as carbon blacks and hydrophobic constituents such as polytetrafluoroethylene (PTFE) and polyvinylidene fluoride (PVDF), and may have a thickness ranging from about 2 to about 100 micrometers. In one embodiment, the microporous layer 56, 62 may include a plurality of particles, for example including graphitized carbon, and a binder. In one embodiment, the binder may include a hydrophobic polymer such as, but not limited to, polyvinylidene fluoride (PVdF), fluoroethylene propylene (FEP), polytetrafluoroethylene (PTFE), or other organic or inorganic hydrophobic materials. The particles and binder may be included in a liquid phase which may be, for example, a mixture of an organic solvent and water to provide dispersion. In various embodiments, the solvent may include at least one of 2-propanol, 1-propanol or ethanol, etc. The dispersion may be applied to a fuel cell substrate, such as, a gas diffusion media layer or a hydrophobic coating over the gas diffusion media layer. In another embodiment, the dispersion may be applied to the hydrophobic layer. The dispersion may be dried (by evaporating the solvent) and the resulting dried microporous layer may include 60-90 weight percent particles and 10-40 weight percent binder. In various other embodiments, the binder may range from 10-30 weight percent of the dried microporous layer.

A variety of different types of membranes 46 may be used in embodiments of the invention. The solid polymer electrolyte membrane useful in various embodiments of the invention may be an ion-conductive material. Examples of suitable membranes are disclosed in U.S. Pat. Nos. 4,272,353 and 3,134,689, and in the Journal of Power Sources, Volume 28 (1990), pages 367-387. Such membranes are also known as ion exchange resin membranes. The resins include ionic groups in their polymeric structure; one ionic component for which is fixed or retained by the polymeric matrix and at least one other ionic component being a mobile replaceable ion electrostatically associated with the fixed component. The ability of the mobile ion to be replaced under appropriate conditions with other ions imparts ion exchange characteristics to these materials.

The ion exchange resins can be prepared by polymerizing a mixture of ingredients, one of which contains an ionic constituent. One broad class of cationic exchange, proton conductive resins is the so-called sulfonic acid cationic exchange resin. In the sulfonic acid membranes, the cationic exchange groups are sulfonic acid groups which are attached to the polymer backbone.

The formation of these ion exchange resins into membranes or chutes is well-known to those skilled in the art. The preferred type is perfluorinated sulfonic acid polymer electrolyte in which the entire membrane structure has ionic exchange characteristics. These membranes are commercially available, and a typical example of a commercial sulfonic perfluorocarbon proton conductive membrane is sold by E. I. DuPont de Nemours & Company under the trade designation Nafion®. Other such membranes are available from Asahi Glass and Asahi Chemical Company. The use of other types of membranes, such as, but not limited to, perfluorinated cation-exchange membranes, hydrocarbon based cation-exchange membranes as well as anion-exchange membranes are also within the scope of the invention.

In one embodiment of the invention, the bipolar plates 10 may include one or more layers of a metal for electrically conductive composite material. In one embodiment, the bipolar plates 10 include stainless steel. The lands 20 and channels 22 may be formed in the bipolar plate 10 by machining, etching, stamping, molding or the like. The lands 20 and channels 22 may define a reactant gas flow field to deliver a fuel on one side of the bipolar plate 10 and an oxidant on the other side of the bipolar plate 10.

In various embodiments the addition of a hydrophobic layer 70, 72, respectively, over the surface of either the cathode electrode 52 or the anode electrode 58, or both the cathode electrode 52 and anode electrode 58, may improve the performance of the fuel cell preventing water from remaining at the interface between the electrode surface and the diffusion media. The removal of water from this interface would enhance gas transport, which is believed to improve fuel cell performance, even under wet conditions.

Moreover, the addition of a hydrophobic layer 70, 72 is also believed to avoid or ameliorate any ionomer “skin” buildup which may be present at the diffusion media/electrode interface that is formed as a result of ionomer migration during the electrode drying process for forming a conventional electrode. This process is thought to be exacerbated at high I/C ratios. The ionomer skin is believed to swell with water and prevent gas transport. Thus, the addition of a hydrophobic layer 70 onto the electrode surface 51 or 53 appears to improve gas transport.

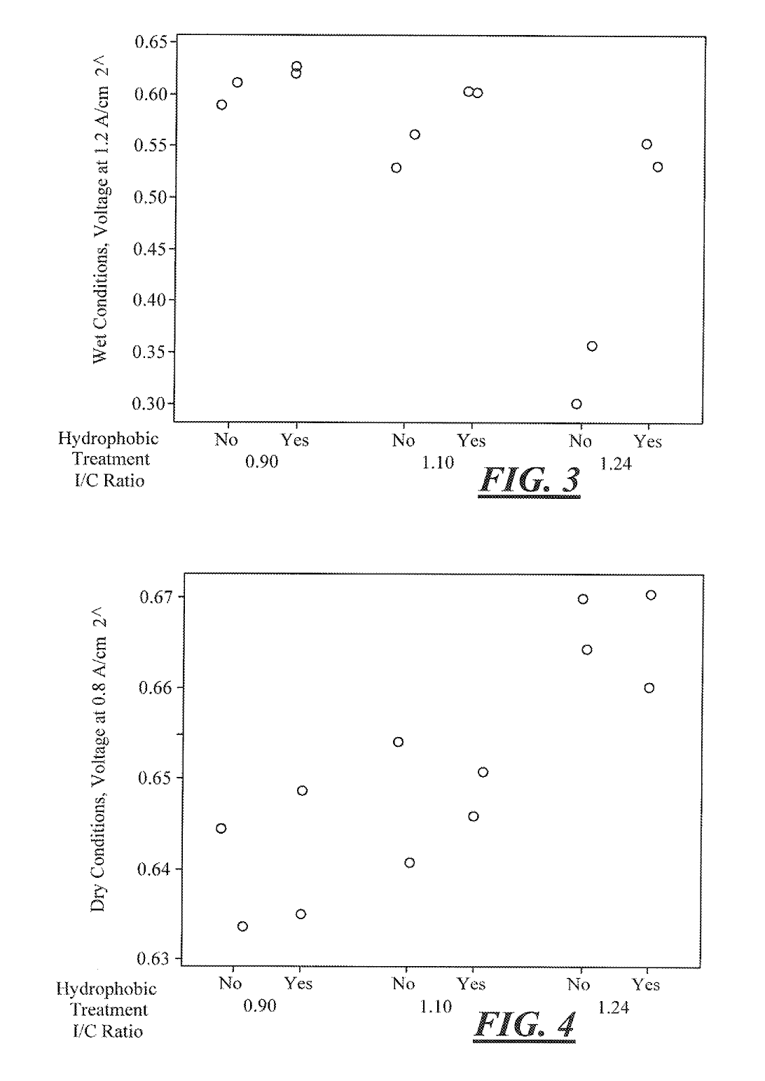

In one exemplary embodiment, the hydrophobic layer 70, 72, may be provided over the surface of the cathode electrodes 52 and the anode electrodes 58 respectively, and the electrodes may be formulated with higher I/C ratios than conventional electrodes without a hydrophobic carbon later. For example, in one exemplary embodiment as confirmed in FIGS. 3 and 4 below, the weight ratio of ionomer to carbon (I/C ratio) may range from 0.9 to 1.24 or higher, so long as the voltage under wet conditions remains essentially constant even at ever increasing I/C ratios. The various embodiments of the higher I/C ratio may improve cell performance in both wet and dry conditions.

To confirm improved fuel cell performance in both wet and dry conditions with the addition of the hydrophobic layer 70 introduced over the surface of the cathode electrode 52 at various I/C ratios, a series of experiments were performed. These are summarized below in FIGS. 3 and 4.

FIG. 3 compares performance under wet conditions for the cathode electrodes 52 at three distinct I/C ratios (0.90, 1.10, and 1.24) with and without a hydrophobic layer 70. The wet conditions utilized for the study were approximately 60 percent relative humidity at about 60 degrees Celsius under hydrogen containing air and with anode/cathode stoichiometry of 1.5/2. The experiment confirms that the wet voltage at 1.2 A/cm² is higher for cathode electrodes with the hydrophobic layer (labeled as hydrophobic treatment) that without the hydrophobic layer of the three I/C ratios tested. The improvement difference, as confirmed by the degree of voltage difference, as illustrated is greater for higher I/C ratios than for lower I/C ratios.

FIG. 4 compares performance under dry conditions for the cathode electrodes 52 listed in FIG. 3. The dry conditions utilized for the study were such wherein the channels for the fuel cell did not contain water, and wherein the relative humidity was approximately 32 percent relative humidity at about 80 degrees Celsius under hydrogen containing air and with anode/cathode stoichiometry of 1.5/2. The experiment confirms that the dry voltage at 0.8 A/cm² is higher for cathode electrodes with the hydrophobic layer (labeled as hydrophobic treatment) that without the hydrophobic layer of the three I/C ratios tested. The improvement difference as illustrated, as confirmed by the degree of voltage difference, is greater for higher I/C ratios than for lower I/C ratios.

The above description of embodiments of the invention is merely exemplary in nature and, thus, variations thereof are not to be regarded as a departure from the spirit and scope of the invention.

What is claimed is:

1. A product comprising:
a first electrode comprising a first layer comprising a catalyst and an electrically conductive hydrophobic layer comprising a hydrophobic material overlying and bonded to the first layer.

2. The product of claim 1, wherein said hydrophobic material comprises a fluorinated polymer.

3. The product of claim 2, wherein said fluorinated polymer comprises at least one of polytetrafluoroethylene, fluorinated ethylene-propylene, perfluoroalkoxy polymer resin, methylfluoroalkoxy polymer resin, polychlorotrifluroethylene, polyvinylidene fluoride, polyvinyl fluoride, ethylene chlorotrifluroethylene, a copolymer of tetrafluoroethylene, hexafluoropropylene and vinylidene fluoride or copolymers of fluorinated polymers thereof.

4. The product of claim 2, wherein said hydrophobic material further comprises carbon particles intermixed with said fluorinated polymer.

5. The product of claim 1, wherein said electrically conductive hydrophobic layer has a thickness ranging from about 0.5 micrometers to about 50 micrometers.

6. The product of claim 1, wherein said electrically conductive hydrophobic layer is laminated or hot pressed to said outer surface of the first layer.

7. The product of claim 1, wherein said first layer comprises a solid polymer electrolyte membrane.

8. A product as set forth in claim 1 further comprising an ion conductive membrane underlying the first layer.

9. A product as set forth in claim 1 further comprising a gas diffusion media layer over and nearest to the electrically conductive hydrophobic layer.

10. A product as set forth in claim 9 further comprising a microporous layer interposed between the gas diffusion media layer and the electrically conductive hydrophobic layer.

11. A product as set forth in claim 10 wherein the microporous layer is bonded or adhered to the gas diffusion media layer.

12. A product as set forth in claim 1 wherein the first electrode further comprises an ionomer and wherein the electrode is substantially free of an ionomer skin.

13. A product comprising an electrode for use in a fuel cell comprising a hydrophobic material, wherein the electrode includes a first portion comprising a catalyst and a second portion being substantially free of catalyst and wherein the hydrophobic material is only in the second portion.

14. A method comprising:
providing a membrane;
forming a cathode electrode;
coupling said cathode electrode to a first surface of said membrane;
forming an anode electrode;
coupling said anode electrode to a second surface of said membrane such that said membrane is between said anode electrode and said cathode electrode;
forming an electrically conductive hydrophobic layer; and
bonding said electrically conductive hydrophobic layer onto an exterior surface to one of said cathode electrode and said anode electrode.

15. The method of claim 14, wherein forming an electrically conductive hydrophobic layer comprises:
forming a mixture by blending carbon particles with a hydrophobic material and optionally with a solvent and a surfactant;
applying said mixture to an exterior surface of one of said cathode electrode and said anode electrode.

16. The method of claim 14, wherein forming an electrically conductive hydrophobic layer comprises:
forming a mixture by blending carbon particles with a hydrophobic material and optionally with a solvent and a surfactant;
applying said mixture to a substrate material;
drying said mixture to remove said optional solvent; and
treating said mixture at an elevated temperature and remove said optional surfactant to form the electrically conductive hydrophobic layer.

17. The method of claim 14, wherein adhering said electrically conductive hydrocarbon layer onto an exterior surface comprises:
laminating said electrically conductive hydrophobic layer onto an exterior surface to one of said cathode electrode and said anode electrode; and
removing said substrate material.

18. The method of claim 14, wherein adhering said electrically conductive hydrocarbon layer onto an exterior surface comprises:
hot melting said electrically conductive hydrophobic layer onto an exterior surface to one of said cathode electrode and said anode electrode; and
removing said substrate material.

19. The method of claim 14, wherein said hydrophobic material comprises a fluorinated polymer comprising at least one of polytetrafluoroethylene, fluorinated ethylene-propylene, perfluoroalkoxy polymer resin, methylfluoroalkoxy polymer resin, polychlorotrifluroethylene, polyvinylidene fluoride, polyvinyl fluoride, ethylene chlorotrifluroethylene or copolymers of fluorinated polymers thereof.

20. The method of claim 14, wherein the electrically conductive hydrophobic layer thickness ranges from about 0.5 to about 50 micrometers.

21. A method comprising:
providing a decal;
forming an electrode;
coupling said electrode to a first surface of said decal to form an electrode coated decal;
forming an electrically conductive hydrophobic layer; and
adhering said electrically conductive hydrophobic layer onto an exterior surface of said electrode coated decal.

22. The method of claim 21, wherein said electrically conductive hydrophobic layer thickness ranges from about 0.5 to about 50 micrometers.

23. The method of claim 21 further comprising removing said decal.

24. A product as set forth in claim 21 wherein the electrode further comprises carbon particles and wherein the weight ratio of ionomer/carbon ranges is equal to or greater than 0.94.

25. A method comprising:
providing an ion conducting membrane;
forming an electrode;
coupling said electrode to a first surface of said ion conducting membrane;
forming an electrically conductive hydrophobic layer; and
bonding said electrically conductive hydrophobic layer onto an exterior surface of said electrode.

26. The method of claim 25, wherein said electrically conductive hydrophobic layer thickness ranges from about 0.5 to about 50 micrometers.

27. The method of claim 25, wherein said ion conducting membrane is supported by a decal.

28. The method of claim 25, wherein said ion conducting membrane is supported by a catalyst coated diffusion media.
